(19) United States
(12) Patent Application Publication
(10) Pub. No.: US 2019/0317464 A1
(43) Pub. Date: Oct. 17, 2019

(54) A Ticket Management System

(71) Applicant: Siemens Schweiz AG, Zuerich (CH)

(72) Inventor: Christian Frey, Unterägeri (CH)

(73) Assignee: Siemens Schweiz AG, Zuerich (CH)

(21) Appl. No.: 16/316,967

(22) PCT Filed: Jun. 19, 2017
(86) PCT No.: PCT/EP2017/064935

§ 371 Date: Jan. 10, 2019

(30) Foreign Application Priority Data
Jul. 11, 2016 (DE) 10 2016 212 550.8

(51) Int. Cl. G05B 19/042; G06Q 10/00

(52) U.S. Cl. CPC G05B 19/0428; G06Q 10/20; G05B 2219/24012; G05B 2219/24001; G05B 2219/24048

(57) ABSTRACT

Various embodiments may include a method for managing service requests comprising: receiving a report at a reporting center from a first mobile communication terminal associated with a user, including a detected fault, a location, and a photograph taken with the mobile communication terminal; creating a corresponding service ticket in the reporting center; sending the service ticket from the reporting center to a second mobile communication terminal associated with a service representative; and, after the fault has been cleared, returning the service ticket from the mobile communication terminal to the reporting center, wherein the returned service ticket comprises a photograph of the cleared fault and a location of the cleared fault.

### CROSS-REFERENCE TO RELATED APPLICATIONS

This application is a U.S. National Stage Application of International Application No. PCT/EP2017/064935 filed Jun. 19, 2017, which designates the United States of America, and claims priority to DE Application No. 10 2016 212 550.8 filed Jul. 11, 2016, the contents of which are hereby incorporated by reference in their entirety.

### TECHNICAL FIELD

The present disclosure relates to managing work requests. Various embodiments may include a method for operating a ticket management system for faults/requests and/or a corresponding ticket management system.

### BACKGROUND

For economic and environmental reasons, service representatives or facility managers (FM) may check installed infrastructure and consumables according to their usage. Although a corresponding inspection interval is matched to consumption, wear, or lifetime, for reasons of cost, it is often delayed for as long as feasibly possible. Many systems and facilities are not networked or not equipped with networked displays such as, for example, consumption indicators (water level in plant pots, soap dispensers, toilet paper, fire extinguishers, etc.). Of course, facilities (lights, coffee machines, hot water system, etc.) may become prematurely defective. Often, then, a deficiency or an error will only be noticed by the facility manager (e.g. janitor) or the responsible service engineer on the next routine check, if at all. In addition, under some circumstances, defective or damaged systems such as, for example, a broken socket, broken windows, loose-hanging ceiling parts, etc. could injure people or even endanger life. Furthermore, failure to observe safety regulations, such as, for example, the requirement to keep emergency exits free of obstacles, should be reported as soon as possible in order to rectify the deficiency promptly.

As a rule, users of systems or building facilities can report such irregularities to a service center via a telephone number. However, this requires knowledge of the relevant contact details (telephone number, email address, website, etc.) of the service center. After this, they have to describe the system and the deficiency and give details of the precise location (floor, room number, etc.). This is inconvenient and can easily lead to misunderstandings and thereby give rise to further unnecessary steps thus increasing the amount of work and hence the costs of correcting deficiencies.

### SUMMARY

The teachings of the present disclosure describe a simple-to-implement method for operating a ticket management system for faults. For example, some embodiments may include a method for operating a ticket management system for faults, wherein a mobile communication terminal of a user is set up to send a report regarding a detected fault to a reporting center, wherein the report comprises the location of the fault and one or more photographs of the fault taken by a camera of the mobile communication terminal, wherein the mobile communication terminal is further set up to determine the location of the fault; wherein a corresponding service ticket is created in the reporting center based on the report; wherein the service ticket is sent by the reporting center to a mobile communication terminal of a service representative, wherein the mobile communication terminal of the service representative is set up to receive the service ticket sent by the reporting center and output said service ticket on an output unit; wherein after the fault has been cleared, the mobile communication terminal of the service representative returns the service ticket to the reporting center, wherein the returned service ticket comprises a photograph of the cleared fault and the location of the fault clearance. This enables detected faults to be reported by a user in a simple, ad-hoc and quick manner, i.e. without any bureaucratic obstacles.

As another example, some embodiments may include a method for operating a ticket management system for faults, wherein a mobile communication terminal (MG1) of a user is set up to send a report (TR) regarding a detected fault (ST) to a reporting center (MZ), wherein the report (TR) comprises the location of the fault (ST) and one or more photographs of the fault (ST) taken by a camera of the mobile communication terminal (MG1), wherein the mobile communication terminal (MG1) is further set up to determine the location of the fault (ST); wherein a corresponding service ticket (T) is created in the reporting center (MZ) based on the report (TR); wherein the service ticket (T) is sent by the reporting center (MZ) to a mobile communication terminal (MG2) of a service representative (SB1), wherein the mobile communication terminal (MG2) of the service representative (SB1) is set up to receive the service ticket (T) sent by the reporting center (MZ) and to output said service ticket on an output unit; and wherein after the fault (ST) has been cleared, the mobile communication terminal (MG2) of the service representative (SB1) returns the service ticket (TF) to the reporting center (MZ), wherein the returned service ticket (TF) comprises a photograph of the cleared fault (ST) and the location of the fault clearance.

In some embodiments, the reporting center (MZ) closes the service ticket (TF) returned to it after verification of the cleared fault (ST), wherein the verification comprises a detected conformity between the location of the fault (ST) and the location of the fault clearance.

In some embodiments, the report (TR) further comprises: user comments.

In some embodiments, the report (TR) also describes a deficiency state.

In some embodiments, the reporting center (MZ) analyzes a received report (TR) and, based on this analysis, the service ticket (T) created is enhanced by a reference to a required tool and/or a reference to a required consumable and/or a reference to required spare parts and/or a reference to the required repair time and/or a reference to a required specialist (SB1, SB2) with a special skill.

In some embodiments, the location of the report and the location of the fault clearance are determined by a position-determining system (SAT, IPS) with the respective mobile communication terminal (MG1-MG3) and the corresponding geographic coordinates of the installed software application (fault app) are provided.

As another example, some embodiments may include an arrangement for carrying out a method as described above.

As another example, some embodiments may include a ticket management system, wherein a mobile communication terminal (MG1) of a user (B) has a software application (fault app) which can send a report (TR) regarding a detected fault (ST) or a deficiency to a server for a reporting center (MZ), wherein the report (TR) comprises the location of the fault (ST) or the deficiency and one or more photographs of the fault (ST) taken by a camera of the mobile communication terminal (MG1), wherein the mobile communication terminal (MG1) is further set up to determine the location of the fault (ST); wherein, based on the report (TR), the server for the reporting center (MZ) is able to create a corresponding service ticket (T) and send said service ticket to a mobile communication terminal (MG2) of a service representative (SB1), wherein the mobile communication terminal (MG1) of the service representative (SB1) is set up to receive the service ticket (T) sent by the reporting center (MZ) including the geographic coordinates and to output said service ticket on an output unit; wherein the mobile communication terminal (MG2) of the service representative (SB1) is further set up to display the location of the fault (ST) and to navigate the service representative (SB1) to said location; and wherein after the fault (ST) has been cleared, the mobile communication terminal (MG2) of the service representative (SB1) can return the service ticket (TF) to the reporting center (MZ), wherein the returned service ticket (TF) comprises a photograph of the cleared fault (ST) and the location of the fault clearance.

In some embodiments, the server for the reporting center (MZ) is set up to close the service ticket (TF) returned to it automatically after verification of the cleared fault, wherein the verification comprises a detected conformity between the location of the report and the location of the fault clearance.

In some embodiments, the location of the report and the location of the fault clearance is determined by a position-determining system (SAT, IPS) with the respective mobile communication terminal (MG1-MG3) and the corresponding geographic coordinates of the installed software application are provided.

In some embodiments, if required, the software application (fault app) for sending the report (TR), can be installed on the mobile communication terminal (MG1) of the user (B).

### BRIEF DESCRIPTION OF THE DRAWINGS

The teachings and example embodiments of the present disclosure are described below using the example of the following figures, which show:

FIG. 1 a first exemplary arrangement for a ticket management system for processing fault or deficiency reports, incorporating the teachings of the present disclosure;

FIG. 2 a second exemplary arrangement for a ticket management system for processing fault or deficiency reports, incorporating the teachings of the present disclosure; and

FIG. 3 an exemplary flow diagram for a method for operating a ticket management system incorporating the teachings of the present disclosure.

### DETAILED DESCRIPTION

In some embodiments, the reporting center closes the service ticket returned to it after verification of the cleared fault, wherein the verification comprises a detected conformity between the location of the fault and the location of the fault clearance. The location of the fault and the location of the fault clearance are in each case reported by different people. Comparison of the geographic coordinates enables it to be ensured that the fault clearance also actually took place at the location of the reported fault.

In some embodiments, the report further comprises: user comments. The user can add comments to the fault report in the form of text and/or as a voice message. This makes the description of the fault more specific and more comprehensive.

In some embodiments, the report comprises a deficiency state. A report can also refer to a deficiency state, for example “soap dispenser empty”.

In some embodiments, the reporting center analyzes a received report and, based on this analysis, the service ticket created is enhanced by a reference to a required tool and/or a reference to required consumables and/or a reference to required spare parts and/or a reference to the required repair time and/or a reference to a required specialist with a special skill.

In some embodiments, the reporting center is able to access an empirical database with information on known faults (e.g. tool required, time required for fault clearance, skills required). Such information makes it easier for the relevant service representative to plan the fault clearance strategy. The analysis of the received fault report can be performed in a server for the reporting center, for example by artificial intelligence (AI) mechanisms, i.e. with corresponding software.

In some embodiments, the location of the report and the location of the fault clearance are determined by a position-determining system with the respective mobile communication terminal and the corresponding geographic coordinates of the installed software application (fault app) are provided. Position-determining systems, for example satellite-based (e.g. GPS) cellphone-based (e.g. GSM), or indoor-positioning systems (IPS, for example iBeacon, WLAN) are widely used and are able to determine the position of a mobile communication terminal (e.g. a smartphone, tablet computer) very easily.

Some embodiments include an arrangement for carrying out the methods described above. The components required to implement the arrangement are commercially available hardware or software or corresponding tailor-made software. For example, a ticket management system, wherein a mobile communication terminal of a user comprises a software application (fault app) which can send a report regarding a detected fault or a deficiency to a server for a reporting center, wherein the report comprises the location of the fault or the deficiency and one or more photographs of the fault taken by a camera of the mobile communication terminal, wherein the mobile communication terminal is further set up to determine the location of the fault; wherein, based on the report, the server for the reporting center is able to create a corresponding service ticket and send said service ticket to a mobile communication terminal of a service representative, wherein the mobile communication terminal of the service representative is set up to receive the service ticket sent by the reporting center, including the geographic coordinates, and to output said service ticket on an output unit; wherein the mobile communication terminal of the service representative is further set up to display the location of the fault and to navigate the service representative to said location; wherein after the fault has been cleared, the mobile communication terminal (e.g. a smartphone, tablet computer) of the service representative can return the service ticket to the reporting center, wherein the returned service ticket comprises a photograph of the cleared fault and the location of the fault clearance. The components required to implement the arrangement are commercially available hardware or software or corresponding tailor-made software.

In some embodiments, the server for the reporting center is set up to close the service ticket returned to it automatically after verification of the cleared fault, wherein the verification comprises a detected conformity between the location of the report and the location of the fault clearance. The location of the fault and the location of the fault clearance is in each case reported by different people. Comparison of the geographic coordinates enables it to be ensured that the fault clearance also actually took place at the location of the reported fault. The server for the reporting center, for example a correspondingly configured PC or a correspondingly configured workstation, can, for example access an empirical database comprising corresponding entries for the fault reports (e.g. a photograph of a fault-free object). Automatic comparison of photographs of a cleared fault sent by a service representative with a corresponding photograph in the empirical database enables the reporting center to verify a cleared fault automatically and to close a corresponding ticket automatically. The comparison can, for example, be performed by a corresponding pattern recognition system or image recognition system.

In some embodiments, the location of the report and the location of the fault clearance are determined by a position-determining system with the respective mobile communication terminal and the corresponding geographic coordinates of the installed software application are provided. Position-determining systems, for example satellite-based (e.g. GPS), or cell phone-based (e.g. GSM), or indoor positioning systems (IPS; for example, iBeacons, WLAN) are widely used and are able to determine the position of a mobile communication terminal (e.g. a smartphone, tablet computer) very easily.

In some embodiments, the software application (fault app) for sending the report (on demand) to the mobile communication terminal (e.g. a smartphone) of the user can be installed, for example by downloading via an app store or by scanning in a QR code that is attached in or on a building (e.g. in the entrance hall of a building or in the elevators). The QR code can contain an actual corresponding program (fault app) or a URL with a link to the program.

A user (person) can use a smartphone app, which, depending on the building/location, can, for example, be loaded and installed via a QR code sticker at the entrance or in the corridors, to report any faults (defects) detected or deficient supplies (consumables, water for flowers). To this end, the user launches a corresponding app on a mobile communication terminal (e.g. a smartphone, tablet computer) and the user creates a photograph, possibly with a short description of the deficiency or the fault. For example, the location of the irregularity is already known by means of an indoor positioning system (IPS) and is sent to the server for the corresponding service center (e.g. reporting center, building management system). There, on receipt of the message, a service ticket is created (immediately, automatically or, after verification, semi-automatically). This ticket is then displayed via the service app on the cell phone (e.g. a smartphone) of the responsible service technician or engineer, who can then travel to the site with the specific corresponding materials required to clear the fault or rectify the deficiency.

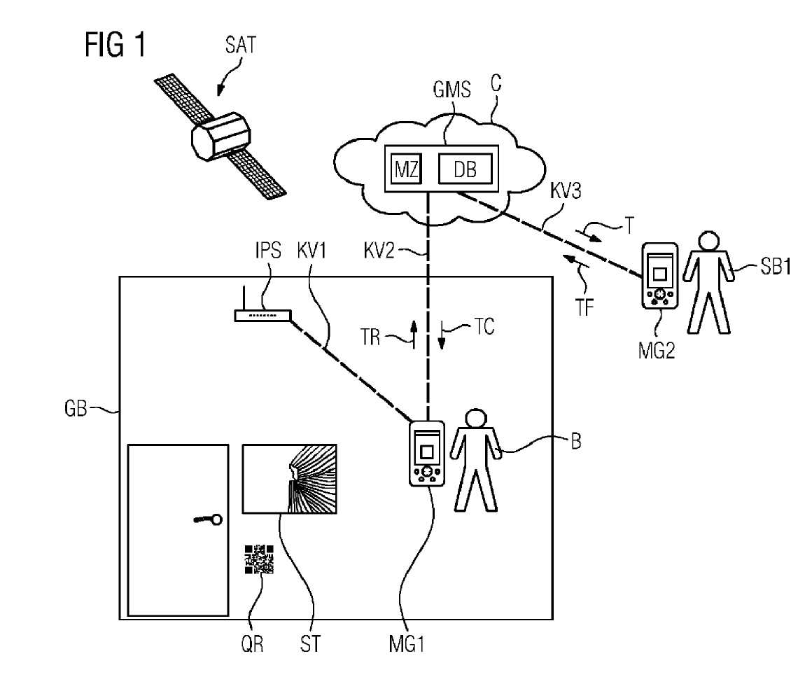

FIG. 1 shows an example arrangement for a ticket management system for processing fault or deficiency reports, wherein a mobile communication terminal MG1 of a user B comprises a software application (fault app) which can be used to send a report TR regarding a detected fault or a deficiency to a server for a reporting center MZ, wherein the report TR comprises the location of the fault ST or the deficiency and one or more photographs of the fault taken by a camera of the mobile communication terminal MG1, wherein the mobile communication terminal MG1 is further set up to determine the location of the fault; wherein the server for the reporting center MZ can create a corresponding service ticket T based on the report TR (e.g. a ticket request) and send said service ticket to a mobile communication terminal MG2 of a service representative SB1, wherein the mobile communication terminal MG2 of the service representative SB1 is set up to receive the service ticket T sent by the reporting center MZ including the geographic coordinates and to output said service ticket on an output unit (e.g. display on the mobile communication terminal MG2); wherein the mobile communication terminal MG2 of the service representative SB1 is further set up to display the location of the fault and to navigate the service representative SB1 to said location; wherein after the fault ST has been cleared, the mobile communication terminal MG2 of the service representative SB1 can return the service ticket TF (ticket finished) to the reporting center MZ, wherein the returned service ticket TF comprises a photograph of the cleared fault ST and the location of the fault clearance.

In the depiction shown in FIG. 1, the fault ST detected by the user B is by way of example a broken window in a building GB. The communications terminals MG1, MG2 are, for example, smartphones or tablet computers. The communication links KV1-KV3 may comprise radio-based or mobile-radio-based links. The reporting center MZ can, for example, be part of a building management system GMS. The reporting center MZ comprises a correspondingly configured server (e.g. PC, workstation) for receiving fault or deficiency reports TR (ticket request) via the communication link KV2. A position-determining system SAT and/or IPS determines the position of the mobile device MG1 of the user B. In some embodiments, the reporting center MZ or the server for the reporting center and the database DB are located in a cloud (computer cloud). This enables the services of the ticket management system to be provided as “Software-as-a-Service” (SaaS) or also as “Infrastructure-as-a-Service” (IaaS) for example for building operators. Hence, building operators do not themselves have to design or operate a ticket management system for processing faults for their buildings. Hence, building operators are able to outsource their ticket management systems.

The user B of the mobile device MG1 creates a photograph of a detected fault ST (e.g. a broken window in the building GB). Faults ST detected by the user B are sent as fault or deficiency reports as a ticket request TR via the communication link KV2 (e.g. a radio link) to the reporting center MZ. The ticket request TR comprises a photograph of the fault ST and the position of the fault ST. This enables the nature and severity of the fault to be easily identified in the reporting center MZ and, in addition, the precise location of the fault ST is known. Hence, a service representative SB1 can be provided appropriately with all the information required (e.g. tool required, spare parts required, skills required), time required (for travel and for the fault clearance)) to clear the fault ST. Advantageously, the server for the reporting center MZ is able to access an empirical database DB with information (e.g. tool required, time required for the fault clearance, skills required) on known faults. This makes it easier for a corresponding service representative SB1 to plan the fault clearance strategy. The database DB can, for example, be a relational database. In principle, a spreadsheet (e.g. Excel) with the corresponding information is also sufficient.

In some embodiments, the location of the communication terminals MG1, MG2 during the detection of the fault or the fault clearance is obtained by position-determining systems SAT, IPS. Position-determining systems SAT, IPS, for example satellite-based (e.g. GPS tracking), or mobile-radio-based (e.g. GSM tracking) or indoor positioning systems (IPS, indoor positioning system; for example, iBeacons, WLAN) are widely used and are able to determine the position of a mobile communication terminal MG1, MG2 (e.g. a smartphone, tablet computer) very easily. Herein, the location of the report and the location of the fault clearance is determined by the position-determining system SAT, IPS with the respective mobile communication terminal MG1, MG2 and the corresponding geographic coordinates of the installed software application are provided.

In some embodiments, the software application (fault app) for sending a fault report TR can be run on the mobile communication terminal MG1 of the user B by downloading from the internet. The software application (fault app) can, for example, be located in an app store and downloaded from there by the mobile communication terminal MG1 of the user B or a service representative SB1. However, if required, the software application (fault app) for sending a fault report TR can also be installed on the mobile communication terminal MG1 of the user B, for example by scanning in a QR code QR, which is attached in or on a building GB (e.g. in the entrance hall of a building GB or in the elevators). The QR code QR can contain the corresponding program (fault app) itself or a URL with a link to the program (fault app).

In some embodiments, a fault ST detected by a user B is photographed on the user's mobile communication terminal (e.g. a smartphone) MG1 and sent in the form of a ticket request TR (reported fault) with the photograph and the geographical data of the mobile communication terminal MG1 determined by the position-determining system SAT, IPS to the reporting center MZ via a suitable communication link KV2 (e.g. a radio link). Depending upon the nature of the fault, a ticket T for a fault clearance is created in the reporting center MZ for a suitable service representative SB1 and sent via a suitable communication link KV3 to the mobile communication terminal MG2 (e.g. a smartphone) of the service representative SB1. After clearance of the fault, the service representative SB1 takes a photograph of the location with a mobile communication terminal MG2. Herein, the position-determining system SAT, IPS determines the geographical data of the mobile communication terminal MG2 of the service representative SB1.

The photograph with the cleared fault and the geographical data of the mobile communication terminal MG2 of the service representative SB1 are sent as a “ticket finished report” TF to the reporting center MZ. In some embodiments, the server of the reporting center MZ is set up to close the service ticket TF returned to it automatically after verification of the cleared fault, wherein the verification comprises a detected conformity between the location of the report and the location of the fault clearance. If the reporting center MZ considers the fault ST to have been cleared, a “finished report” TC (ticket closed) may be sent to the user B.

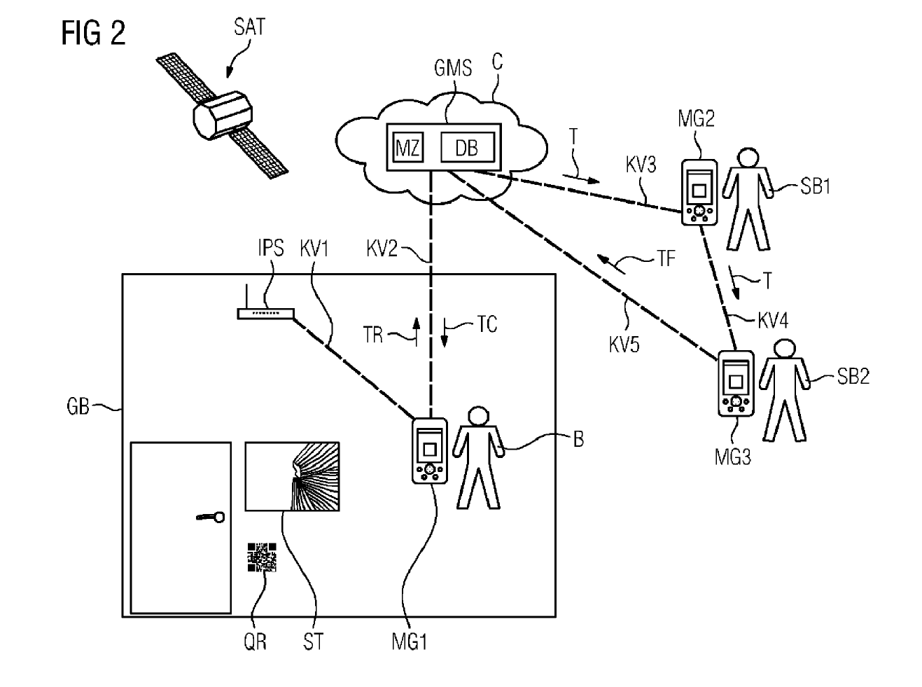

FIG. 2 shows an example arrangement for a ticket management system for processing fault or deficiency reports. The depiction shown in FIG. 2 is an expansion of the scenario in FIG. 1. In the scenario shown in FIG. 1, it is the service representative SB1 appointed by the reporting center MZ who clears the fault and sends a “ticked finished report” TF to the reporting center MZ. In the scenario shown in FIG. 2, the service representative SB1 forwards the received ticket T (for fault clearance) to a service representative SB2 who then performs the fault clearance. This is in particular advisable in cases in which the service representative SB1 identifies that a specialist or an expert (service representative SB2) is required to clear the fault ST.

When the fault has been cleared, the service representative SB2 (e.g. a specialist) takes a photograph of the location of the fault with a mobile communication terminal MG3. Herein, the position-determining system SAT, IPS determines the geographical data of the mobile communication terminal MG3 of the service representative SB2. The photograph with the cleared fault and the geographical data on the mobile communication terminal MG3 of the service representative SB2 is sent as a “ticket finished report” TF to the reporting center MZ. If the reporting center MZ considers that the fault ST has been cleared, advantageously a “finished report” TC (ticket closed) is sent to the user B.

In some embodiments, the communication links KV1 to KV5 may comprise radio links (e.g. mobile radio or satellite radio link). The reports TR, TC, T, TF sent, can, for example, be sent as messenger reports (e.g. via instant messaging services such as, for example, WhatsApp), SMS, or emails. In principle, the reports TR, TC, T, TF can also be sent via social networks (e.g. Facebook, Instagram, Twitter), wherein the subscribers B, MZ, SB1, SB2 have a corresponding account.

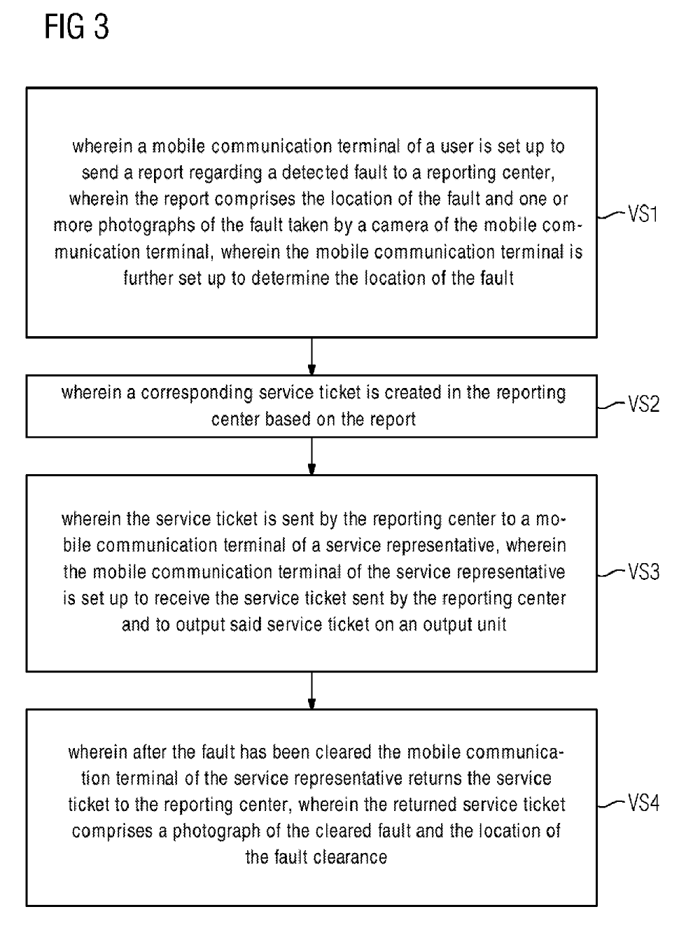

FIG. 3 shows an exemplary flow diagram for a method for operating a ticket management system for faults, (VS1) wherein a mobile communication terminal of a user is set up to send a report regarding a detected fault to a reporting center, wherein the report comprises the location of the fault and one or more photographs of the fault taken by a camera of the mobile communication terminal, wherein the mobile communication terminal is further set up to determine the location of the fault; (VS2) wherein a corresponding service ticket is created in the reporting center based on the report; (VS3) wherein the service ticket is sent by the reporting center to a mobile communication terminal of a service representative, wherein the mobile communication terminal of the service representative is set up to receive the service ticket sent by the reporting center and to output said service ticket on an output unit; and (VS4) wherein after the fault has been cleared, the mobile communication terminal of the service representative returns the service ticket to the reporting center, wherein the returned service ticket comprises a photograph of the cleared fault and the location of the fault clearance.

In principle, the method can be implemented with an existing infrastructure or with existing components. Position-determining systems are in principle universally available, namely inside buildings (IPS, WLAN, iBeacons, etc.) and outside buildings (e.g. satellite-based position-determining systems, such as, for example, GPS). Mobile communication terminals (e.g. smartphones, tablet computers) are widely used and comprise inter alia a camera and position-determining mechanisms. The infrastructure of the reporting center, such as server and database can be implemented using commercially available hardware (e.g. PC, workstations) or software. The corresponding software (fault app) for the mobile communication terminals can be provided by an app provider and, for example, installed via an app store by means of a corresponding download onto the mobile communication terminals.

Various embodiments of the present disclosure may, inter alia, offer the following advantages over known systems:
Cumbersome and complex methods for reporting a deficiency often deter the users of building from reporting such deficiencies. The service app or fault app on the smartphone makes this task very easy and quick to perform and in addition it is enjoyable. Any user of the facility can report the deficiency easily (including anonymously) without the need for a specialist or representative first having to see for themselves. The responsible service engineer or the FM is sent this ticket and as a rule sees immediately from the photographs and the description which spare part or consumable should be taken to the site. If necessary, the person who made the report can be contacted at the site and asked for more details or more photographs. Furthermore, the service engineer is directed straight to the location of the deficiency by means of GPS+IPS. This eliminates the hassle of searching, in particular in the case of people unfamiliar with the site.
This greatly reduces the duration of the deficiency state.

However, this in particular greatly reduces the amount of work and hence the costs of the service engineer, since an analysis or the photographs/images enables specific spare parts or consumables to be taken to the site.
After completion of the work, the service representative can close the ticket with a photograph of the work performed and finished. This can then be sent to the user/client or, if necessary, also to an insurance company as evidence.
A position-determining system (IPS, GPS) helps to reduce the time spent on the hassle of searching for the location of the work and thus also greatly reduces the overall time for the servicing. Moreover, the work log can only be completed, and hence the ticket closed, when this has been acknowledged with the geographic coordinates of the site and a photographic log (geofencing/geocaching). To this end, the geographic coordinates (IPS, Beacon ID) are determined when the ticket is opened by the person making the report (with Bluetooth switched on) and sent with the report to the server and hence included in the log. This verification makes a further contribution to enhanced service quality.
If it should turn out at the site that further skills are required to clear the deficiency, the ticket, possibly enhanced with further comments and photographs, can be forwarded via the reporting center or directly to a specialist.

### REFERENCE CHARACTERS

SAT Satellite

SB1, SB2 Service representative

MG1-MG3 Mobile device

GMS Building management system

IPS Position-determining system

MZ Reporting center

C Cloud

DB Database

GB Building

ST Fault

KV1-KV5 Communication link

TR Ticket request

T Ticket

TF Ticket finished

TC Ticket closed

QR QR code

VS1-VS4 Method step

What is claimed is:

1. A method for managing service requests, the method comprising:
receiving a report at a reporting center from a first mobile communication terminal associated with a user, wherein the report includes a detected fault, a location of the fault, and a photograph of the fault taken by a camera of the mobile communication terminal;
wherein the first mobile communication terminal determines the location of the fault;
creating a corresponding service ticket in the reporting center based on the report;
sending the service ticket from the reporting center to a second mobile communication terminal associated with a service representative, wherein the second mobile communication terminal receives the service ticket and displays the service ticket on an output unit; and
after the fault has been cleared, returning the service ticket from the mobile communication terminal to the reporting center, wherein the returned service ticket comprises a photograph of the cleared fault and a location of the cleared fault.

2. The method as claimed in claim 1, further comprising closing the service ticket at the reporting center after verifying the cleared fault, wherein verifying the cleared fault comprises testing for conformity between the location of the fault and the location of the fault clearance.

3. The method as claimed in claim 1, wherein the report further comprises user comments.

4. The method as claimed in claim 1, wherein the report further comprises a deficiency state.

5. The method as claimed in claim 1, further comprising analyzing a received report at the reporting center and, based on this analysis, enhancing the service ticket with at least one of a reference selected from the group consisting of: a reference to a required tool, a required consumable, required spare parts, a required repair time, and a required skill for a specialist.

6. The method as claimed in claim 1, further comprising determining a location of the report and a location of the fault clearance using a position-determining system with the respective mobile communication terminal and corresponding geographic coordinates of the installed software application.

7. (canceled)

8. A ticket management system comprising:
a first mobile communication terminal associated with a user including an installed software application for sending a report identifying a detected fault or a detected deficiency;
a server for a reporting center configured to receive the report from the first mobile communication terminal;
the report including a location of the fault or the deficiency as determined by the first mobile communication terminal and a photograph taken by a camera of the first mobile communication terminal;
wherein the server is configured to create a corresponding service ticket based on the report and send said service ticket to a second mobile communication terminal;
the second mobile communication terminal associated with a service representative and configured to receive the service ticket and to display said service ticket on an output unit;
wherein the second mobile communication terminal is configured to display the location of the fault and to navigate the service representative to said location; and
wherein after the fault has been cleared, the second mobile communication terminal is configured to return the service ticket to the reporting center, the returned service ticket including a photograph of the cleared fault and the location of the fault clearance.

9. The ticket management system as claimed in claim 8, wherein:
the server is configured to close the service ticket returned to it automatically after verification of the cleared fault; and
verification includes detecting whether the location of the report matches the location of the fault clearance.

10. The ticket management system as claimed in claim 8, wherein the location of the report and the location of the fault clearance are each determined by a position-determining system associated with the respective mobile communication terminal and the corresponding geographic coordinates of the installed software application.

11. The ticket management system as claimed in claim 8, wherein, the software application for sending the report can be installed on the mobile communication terminal of the user.
